(19) United States
(12) Patent Application Publication
(10) Pub. No.: US 2020/0144807 A1
(43) Pub. Date: May 7, 2020

(54) REDUNDANT PROTECTION SYSTEM FOR A HYBRID ELECTRICAL SYSTEM

(71) Applicant: Rolls-Royce North American Technologies Inc., Indianapolis, IN (US)

(72) Inventors: Wesley Garrison, Fort Wayne, IN (US); David Loder, Carmel, IN (US)

(73) Assignee: Rolls-Royce North American Technologies Inc., Indianapolis, IN (US)

(21) Appl. No.: 16/183,431

(22) Filed: Nov. 7, 2018

(51) Int. Cl. H02H 3/087; H01H 61/017; H01H 85/00; H02H 7/26; H02H 9/02

(52) U.S. Cl. CPC H02H 3/087; H01H 61/017; B64D 2221/00; H02H 7/268; H02H 9/02; H01H 85/0047

(57) ABSTRACT

A redundant fault protection architecture for a DC electrical system with a hybrid relay sensing current on a DC rail as primary protection, and a pyrofuse, either self-triggering or externally triggered, as secondary protection. The pyrofuse is set to trigger after a delay to enable the hybrid relay to clear the fault (overcurrent). If the hybrid relay fails to clear the fault within a certain time duration, the pyrofuse subsequently is triggered and clears the fault.

### BACKGROUND

A growing development in aircraft propulsion is to employ electrical components to distribute thrust and achieve ultra high effect bypass ratios, as well as other airframe level benefits such as improved lift to drag ratio. This type of distributed electrical propulsion can be supplemented with electrical energy storage. This type of propulsion system can offer improvements in specific fuel consumption, emissions, and noise. Some of these engine types involve connecting multiple electrically driven propeller to a battery and multiple gas turbine generators, often in a DC microgrid, which allows the battery and generator to share power loading while providing more freedom in operating frequencies than a AC grid would. The onboard microgrid can also enable additional aircraft capabilities for high power electrical loads used in defense and other applications.

In DC electric systems, such as these as others, there is the possibility of a short circuit between the positive and negative DC lines which can lead to a catastrophic failure of the system. If the fault is not cleared very quickly (e.g. less than 100 ms), the system could experience damage. Many existing types of fault protection may not be effective in these DC electrical systems.

Current-limiting fuses provide low cost, easy-to-install, compact, fast and reliable over-current protection for electrical systems from distribution networks, to switching power supplies. Being the most fail-safe and compact solution, since 1950, current-limiting fuse technology has evolved its speed, power rating, and adapting to more extreme working conditions, to protect semiconductor devices or equipment in the new power electronics era. However, limited by thermal physics, fuses' non-controllable nature makes them difficult to address the very basic requirements from transportation DC applications, which are generally demanding for product size, temperature rise, power cycling capability, and precise protection over comparatively low fault current to distribution networks (typically, kAs in battery systems versus tens of kAs in distribution networks).

Circuit breakers are also widely used for short-circuit protection. Their ability to be reset is a major advantage against fuses. Moreover, circuit breakers feature a lower on-state voltage drop in the closed position as well as a galvanic separation in the open state. However, when a fault is detected, breakers operate more slowly than current-limiting fuses due to the large mechanical time constant. In DC networks, the presence of arcs leads to contact erosion and arcing chamber fatigue, i.e. a shorter lifetime and high maintenance costs. A longer time to react to a large fault current leads to higher let-thru current, which will ultimately stress the downstream circuit they are intended to protect.

Hybrid protection systems are being developed to overcome the limitations of fuses and circuit breakers but have limitations of their own. Hybrid relays often employ a combination of solid state relay and mechanical relay. Though they more quickly than circuit breakers may not react quickly enough for a hybrid electrical system. As well hybrid relays are often designed to be normally open and thus main power can be lost if the auxiliary power controlling the relay is lost. Pyrofuses are also being developed. Pyrofuses react very quickly but cut the main power line and cannot be reset to restore power, and are thus not suitable as a primary means of fault clearance in a system where maintaining electrical power is mission critical (e.g. aviation).

It would be advantageous to have a robust protection architecture using normally closed components that enable power to be maintained in the event of an auxiliary power/control power failure, yet react quickly enough to the fault to protect the system.

### SUMMARY

A fault protection architecture in a DC electrical system, the architecture which may include a fault protection circuit positioned in series between a DC source and a DC rail, the fault protection circuit itself may include a hybrid relay; and a pyrofuse in series with the hybrid relay; the hybrid relay having a predetermined triggering condition and a known clearing time; wherein the hybrid relay triggers when the predetermined triggering condition is met on the DC rail; the pyrofuse having a second predetermined triggering condition, wherein the second triggering condition is set such that the pyrofuse trigger is on a delay at least equal to the clearing time of the hybrid relay.

In one embodiment, the predetermined triggering condition may be defined at least as a function of a current threshold. In a further embodiment, the predetermined triggering condition may be defined at least as a function of time. In another embodiment the pyrofuse may be self-triggering. In another embodiment, a current sensing device may be operable connected to the DC source and the hybrid relay. In yet another embodiment a current sensing device, a controller and at least one power supply, the current sensing device operably connected to the DC rail and the controller, the controller operably connected to the power supply and a trigger of the pyrofuse. In yet another embodiment the power supply may be an uninterruptible power supply. An even further embodiment may include a bus selector. At least one power supply may include a non-critical bus and a critical auxiliary power bus, the bus selector connected to the non-critical bus or the critical auxiliary power bus with a switchable mechanism. In another embodiment the pyrofuse may include a pyroswitch arranged in parallel with a conventional fuse. In yet a further embodiment the current sensing device may be a Hall Effect sensor, shunt sensor, or Rogowski coil, In another embodiment the hybrid relay may include a solid-state relay electrically coupled in parallel to a mechanical relay installed in series with the DC rail.

A method of protecting a DC electrical system may include providing a hybrid relay and pyrofuse in series between a DC source and DC rail; subjecting the DC rail to an overcurrent; triggering the hybrid relay in response to the overcurrent; triggering the pyrofuse subsequent to the triggering of the hybrid relay; thereby breaking a conduction path between the DC source and the DC rail. The triggering of the pyrofuse may be delayed by a predetermined time greater than a clearing time of the hybrid relay.

In one embodiment the hybrid relay may include opening the relay. In another embodiment the pyrofuse may be self-triggering. In still another embodiment triggering the pyrofuse further may include sensing the overcurrent and based on the sensed overcurrent applying a power from a power supply to the pyrofuse. In a further embodiment applying power from a power supply may include selecting between a non-critical power bus and a critical auxiliary power bus as the power supply based at least upon availability. In some embodiments the pyrofuse may include a pyroswitch arranged in parallel with a fuse, and triggering the pyrofuse may further include permanently disconnecting the DC source from the DC rail in the pyroswitch and subsequently blowing the fuse. Still yet another embodiment may include a current limiting fuse, and the step of triggering the pyrofuse further may include tripping the current limiting fuse in response to an overcurrent; creating a voltage drop across the current limiting fuse; applying a voltage across a pyroswitch in response to the voltage drop; and, triggering the pyrofuse in response to the voltage.

A fault protection circuit, may include a closed bias relay; and a pyrofuse in series with the relay; the relay having a triggering overcurrent; wherein the relay opens when the triggering overcurrent may be met in the relay; the pyrofuse triggering on a delay with respect to the triggering overcurrent. The delay may be at least greater than a clearing time of the closed relay.

### BRIEF DESCRIPTION OF THE DRAWINGS

The following will be apparent from elements of the figures, which are provided for illustrative purposes.

FIG. 1 depicts a DC microgrid using the redundant protection system.

FIG. 2 depicts a protection coordination curve.

FIG. 3 depicts a coordination curve with the nominal fault clearance.

FIG. 4 depicts a coordination curve with a hybrid relay failure.

FIG. 5 depicts an embodiment of a hybrid relay and a self-triggering pyrofuse.

FIG. 6 depicts an embodiment of a hybrid relay and an externally triggered pyrofuse.

FIG. 7 depicts an embodiment of a hybrid power supply and an externally triggered pyrofuse.

The present application discloses illustrative (i.e., example) embodiments. The claimed inventions are not limited to the illustrative embodiments. Therefore, many implementations of the claims will be different than the illustrative embodiments. Various modifications can be made to the claimed inventions without departing from the spirit and scope of the disclose. The claims are intended to cover implementations with such modifications.

### DETAILED DESCRIPTION

For the purposes of promoting an understanding of the principles of the disclosure, reference will now be made to a number of illustrative embodiments in the drawings and specific language will be used to describe the same.

The present disclosure is directed to systems and methods for fault protection in hybrid electrical systems.

This protection architecture uses a Hybrid Relay as the primary protection device for overcurrent resulting from DC line-to-line fault with Pyrofuse added in series for redundancy. The pyrofuse may be designed to be self-triggered, or to be controlled by an uninterruptible power supply (UPS), which provides a backup to the hybrid relay in case of the device failure. Furthermore, the inclusion of the backup pyrofuse enables the selection of a normally closed hybrid relay, which implies main power is maintained in the event of an auxiliary power/control power failure. This setup could be very desirable/advantageous for aerospace applications that are safety critical, or especially in defense applications when the system can serve the function of “battle ready mode” more robustly.

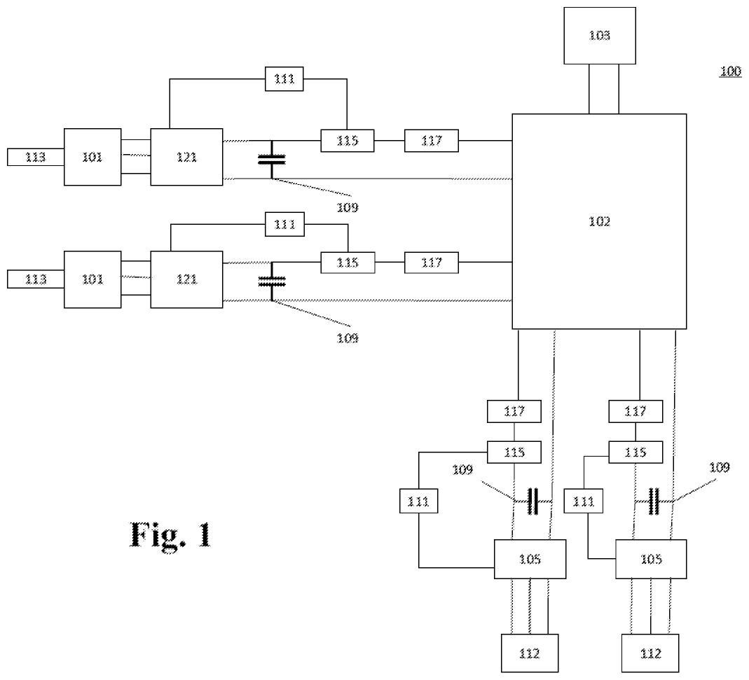

FIG. 1 depicts a DC microgrid 100 powered by multiple generators 101, each driven by a power shaft 113, and a energy storage unit or battery 103. The distribution panel may power AC loads 112, each with its own DC to AC converter 105 protected from the bus by a protection system, which may be a circuit breaker, a relay 115, a pyrofuse 117, or a combination of them. The generator provides power to the distribution panel through redundant sets of DC rails 119. 109 illustrates the DC link capacitors associated with each power converter. A AC to DC converter 121 may be connected to each generator 101 to convert AC power generated by the generator into DC and supply each of the sets of DC rails 119. Overcurrent protection for each set may be handled by a hybrid relay 115 which has a pyrofuse 117 as a backup system. The relay may receive a trigger signal 111 from the AC:DC converter 121 or a sensing device on the rail, indicating a current spike caused by a fault somewhere within the dc microgrid. This hybrid relay 115 will be opened to cut power to the fault. As a backup mean of fault isolation, the pyrofuse 117 may have two parts, the fuse and a pyroswitch. The fuse may have a much higher resistance than the rail and would normally have no current running through it. The pyroswitch employs a small guillotine which normally sits above the rail until triggered, by a small pyrotechnic device. When triggered, the guillotine is forced down through the rail permanently severing the rail, the presence of the fuse in parallel with the rail prevents arcing across the cut rail. The current will instead travel through the fuse until the max current for the fuse is exceeded and the fuse opens thus preventing any arching across the severed rail. The fuse rated to handle high voltage but low currents compared to the rail, ensuring the fuse opens soon after the rail is broken.

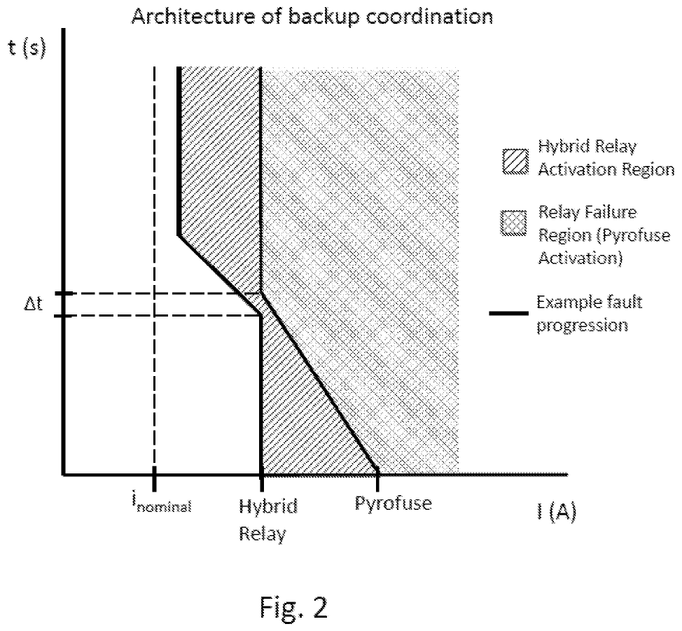

FIG. 2 depicts a protection coordination curve for the system. This is a qualitative curve showing triggering points of the hybrid relay and pyrofuse. One axis represents time elapsed after a fault occurs, while the other axis represents current. The current curve 201 shows an example fault propagation over time. Both the hybrid relay and the pyrofuse activate when the faults current heats the protective devices enough to activate. Thus activation is based both on the amount of current and the duration of the current applied. This relationship is depicted in FIGS. 2-4 by the activation regions. The hybrid relay curve shows the minimum threshold activation current over time for the hybrid relay after a fault has occurred. As can be seen the activation current of the relay drops longer the fault remains in place. The pyrofuse curve shows the minimum threshold activation current of the pyrofuse overtime after the fault occurred. As can be seen the pyrofuse minimum threshold activation current also drops the longer a fault remains uncleared. When the fault current crosses either the hybrid relay or pyrofuse minimum threshold activation current the respective protective device will activate.

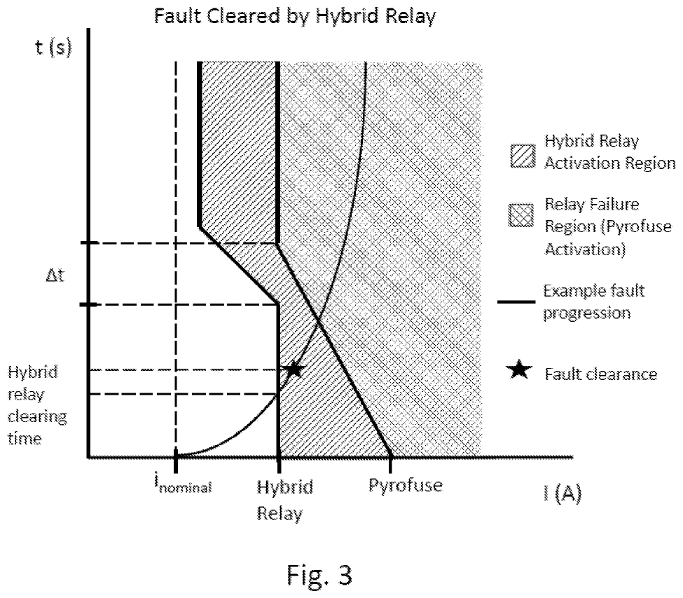

Shown in FIG. 3, there may be a delay between the time the current reaches the threshold (hybrid relay activation region) and when the fault is cleared. This clearing time may be different for the hybrid relay and the pyrofuse. The clearing time of a hybrid relay can be as fast as 3 ms. The hybrid relay may be capable of being reset after the fault is cleared and trigger at a lower current than the pyrofuse. The pyrofuse may have a much shorter clearing time that the hybrid relay, but is destructive to the rail and thus used as a backup. This helps to minimize any potential damage downstream to the bus and electrical equipment if the hybrid relay fails. In order to avoid unnecessary destruction of the rail, the pyrofuse triggering condition is set such that any triggering is delayed until the predetermined clearing time of the hybrid rely has past and then only triggers if the fault is still present and meets the triggering condition (fault extending into the pyrofuse activation region) of the pyrofuse (i.e. the Δt between the pyrofuse and the hybrid relay must be greater that the clearing time of the hybrid relay).

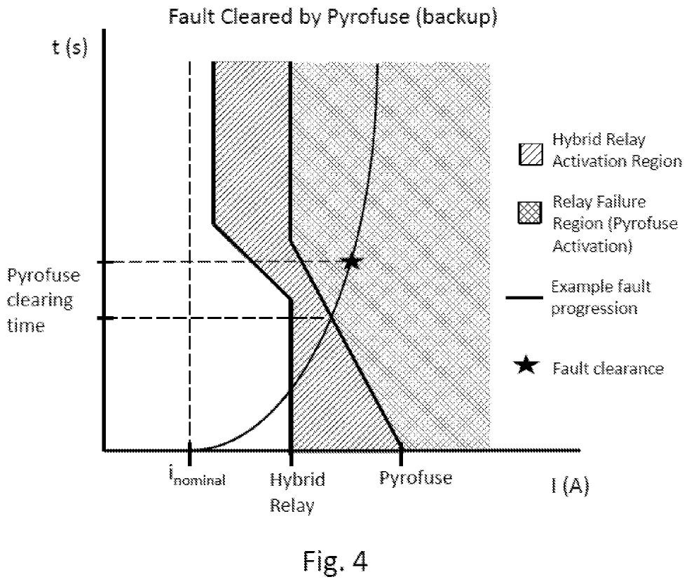

FIG. 4 illustrates a fault scenario in which the hybrid relay protection has failed. Therefore the fault progresses to the pyrofuse clearing curve, and the pyrofuse is triggered in order to break the fault as a backup. Delta t indicates the pyrofuse clearing time in FIG. 4.

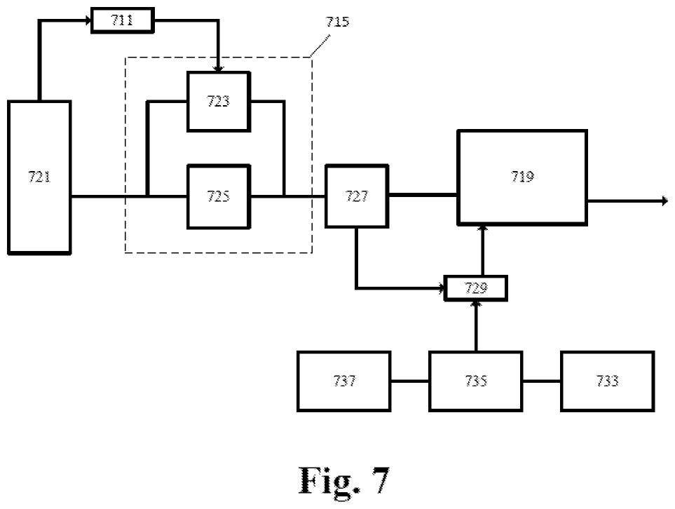

FIGS. 5, 6, and 7 depict three embodiments of the system, each varying by the activation method of the pyrofuse. FIG. 5 depicts use of a self-triggering pyrofuse 517. The hybrid relay may be made up of a solid state relay (SSR) in parallel with a mechanical relay (MR) and a trigger circuit. The trigger circuit may sense the increase of current caused by a fault and a send a signal to the SSR activating it, thereby creating a parallel path for the fault current. The trigger circuit may then send a signal to the MR opening it. Due to the higher resistance a smaller current will travel through the SSR, preventing arcing across the MR, until the trigger circuit sends a signal opening the SSR.

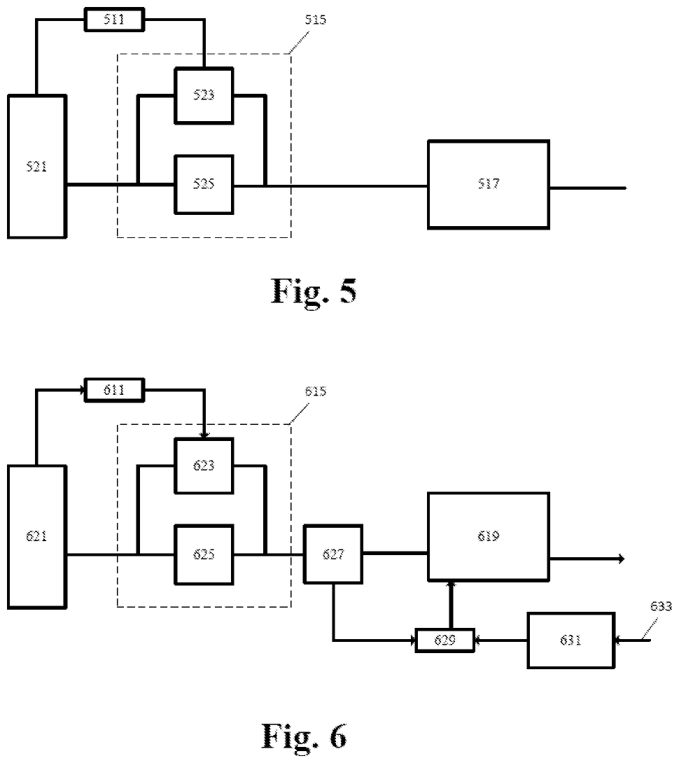

FIG. 6 depicts the use of an externally triggered pyrofuse 619 with the pyroswitch ignited by an electric circuit 629 connected to an uninterruptible power supply. The hybrid relay may be the same as depicted in FIG. 5. A Current sensor 627 senses the current through the rail and when a threshold current is reached the sensor sends a signal to the circuit 629 igniting the pyroswitch. This allows the system to actively control the activation of the pyroswitch but at the cost of more equipment and complexity. The system may also use a healthy bus selector 735 in place of the uninterruptible power supply. This healthy bus selector may have hotel loads 737 and critical auxiliary power 733 giving the benefit of a dedicated UPS without the added weight.

Although examples are illustrated and described herein, embodiments are nevertheless not limited to the details shown, since various modifications and structural changes may be made therein by those of ordinary skill within the scope and range of equivalents of the claims.

What is claimed is:

1. A fault protection architecture in a DC electrical system, the architecture comprising:
a fault protection circuit positioned in series between a DC source and a DC rail,
the fault protection circuit comprising:
a hybrid relay; and
a pyrofuse in series with the hybrid relay;
the hybrid relay having a predetermined triggering condition and a known clearing time; wherein the hybrid relay triggers when the predetermined triggering condition is met on the DC rail;
the pyrofuse having a second predetermined triggering condition, wherein the second triggering condition is set such that the pyrofuse trigger is on a delay at least equal to the clearing time of the hybrid relay.

2. The fault protection architecture of claim 1, wherein the predetermined triggering condition is defined at least as a function of a current threshold.

3. The fault protection architecture of claim 2, wherein the predetermined triggering condition is defined at least as a function of time.

4. The fault protection architecture of claim 1, wherein the pyrofuse is self-triggering.

5. The fault protection architecture of claim 1, wherein a current sensing device is operable connected to the DC source and the hybrid relay.

6. The fault protection architecture of claim 1, further comprising a current sensing device, a controller and at least one power supply, the current sensing device operably connected to the DC rail and the controller, the controller operably connected to the power supply and a trigger of the pyrofuse.

7. The fault protection architecture of claim 6, wherein the power supply is an uninterruptible power supply.

8. The fault protection architecture of claim 6, further comprising a bus selector, wherein the at least one power supply comprises a non-critical bus and a critical auxiliary power bus, the bus selector connected to the non-critical bus or the critical auxiliary power bus with a switchable mechanism.

9. The fault protection architecture of claim 1, wherein the pyrofuse comprises a pyroswitch arranged in parallel with a conventional fuse.

10. The fault protection architecture of claim 6, wherein the current sensing device is a Hall Effect sensor, shunt sensor, or Rogowski coil.

11. The fault protection architecture of claim 1, wherein the hybrid relay comprises a solid-state relay electrically coupled in parallel to a mechanical relay installed in series with the DC rail.

12. A method of protecting a DC electrical system comprising:
providing a hybrid relay and pyrofuse in series between a DC source and DC rail;
subjecting the DC rail to an overcurrent;
triggering the hybrid relay in response to the overcurrent;
triggering the pyrofuse subsequent to the triggering of the hybrid relay; thereby breaking a conduction path between the DC source and the DC rail;
wherein the triggering of the pyrofuse is delayed by a predetermined time greater than a clearing time of the hybrid relay.

13. The method of claim 12, wherein the triggering of the hybrid relay comprises opening the relay.

14. The method of claim 12, wherein the pyrofuse is self-triggering.

15. The method of claim 12, wherein the step of triggering the pyrofuse further comprises sensing the overcurrent and based on the sensed overcurrent applying a power from a power supply to the pyrofuse.

16. The method of claim 15, wherein the step of apply power from a power supply further comprises the selecting between a non-critical power bus and a critical auxiliary power bus as the power supply based upon at least availability.

17. The method of claim 12, wherein the pyrofuse comprises a pyroswitch arranged in parallel with a fuse, and the step of triggering the pyrofuse further comprises permanently disconnecting the DC source from the DC rail in the pyroswitch and subsequently blowing the fuse.

18. The method of claim 14, further comprising a current limiting fuse, and the step of triggering the pyrofuse further comprises;
tripping the current limiting fuse in response to an overcurrent;
creating a voltage drop across the current limiting fuse;
applying a voltage across a pyroswitch in response to the voltage drop; and,
triggering the pyrofuse in response to the voltage.

19. A fault protection circuit, comprising:
a closed bias relay; and
a pyrofuse in series with the relay;
the relay having a triggering overcurrent; wherein the relay opens when the triggering overcurrent is met in the relay;
the pyrofuse triggering on a delay with respect to the triggering overcurrent.

20. The circuit of claim 19, wherein the delay is at least greater than a clearing time of the closed relay.
